(19) United States
(12) Patent Application Publication
(10) Pub. No.: US 2004/0222780 A1
(43) Pub. Date: Nov. 11, 2004

(54) Temperature history displaying medium and manufacturing method thereof and temperature history displaying method using the medium

(76) Inventors: Hiroshi Yamada, Numazu-shi (JP); Masanaka Nagamoto, Susono-shi (JP); Akira Ichikawa, Numazu-shi (JP); Nigel G. Mills, Dayton, OH (US)

Correspondence Address: Christopher C. Dunham, c/o COOPER & DUNHAM LLP, 1185 Ave. of the Americas, New York, NY, 10036, US

(21) Appl. No.: 10/863,067

(22) Filed: Jun. 7, 2004

Related U.S. Application Data
(63) Continuation of application No. 09/268,194, filed on Mar. 15, 1999, now abandoned.

(30) Foreign Application Priority Data
Mar. 16, 1998 (JP) 10-085019
Aug. 28, 1998 (JP) 10-242984

(51) Int. Cl. H02J 7/16

(52) U.S. Cl. 324/110

(57) ABSTRACT

A temperature history displaying medium including a color forming component which includes an electron donating dye and an electron accepting compound and which achieves a colored state by the reaction of the electron donating dye and the electron accepting compound, and a color erasing component which includes a color erasing agent, wherein the color erasing agent has a function to discolor the color forming component in the colored state, wherein the discoloring is triggered upon application of at least one of dotted heat and patterned heat, and wherein a temperature history is determined depending on the discoloring state of the color forming component in the colored state. In addition, a temperature history displaying method using the medium is also provided. Further, a method for manufacturing the medium is provided.

### BACKGROUND OF THE INVENTION

1. Field of the Invention

The present invention relates to a temperature history displaying medium. More particularly, the present invention relates to a temperature history displaying medium which includes a thermosensitive color forming component and a color erasing component, and in which a temperature history of a good is determined by a change of a colored image formed in the temperature history displaying medium which is preserved together with the good.

2. Discussion of the Related Art

Currently, information such as manufacturing date, sell-by date, term of validity and recommended preservation temperature is described on packages or containers of goods such as foods, medicines and the like. However, the temperature history information of the goods, such as, temperature conditions under which the goods have been preserved, is not clear. Namely, the goods have not necessarily been preserved at the recommended preservation temperature, and may have been preserved at a relatively high temperature or a relatively low temperature for a while. If the goods have been preserved at a relatively high temperature, the sell-by date thereof should be shortened. On the contrary, if the goods have been preserved at a relatively low temperature, the sell-by date should be prolonged. Therefore a temperature history displaying medium which can simply display the history of goods has been especially desired.

Conventional temperature history displaying media using a change of color or color density are as follows:

(1) Media using capillarity of liquid-permeable materials (for example, Japanese Laid-Open Patent Publications Nos. 50-60262 and 61-53531)

Japanese Laid-Open Patent Publication No. 50-60262 discloses a medium which uses a liquid-permeable material such as filter paper, and a colored liquid which is contained in a container and discharged upon application of pressure. A temperature history of a good is determined by a change of the medium in color. The patent application also discloses a medium which uses a coloring agent which achieves a liquid state at a specified temperature, and a liquid-permeable material which includes a color developer. A temperature history of a good is determined by a color change of the medium in which the coloring agent achieves a liquid state at a temperature higher than a specified temperature and then penetrates the permeable material, resulting in color formation by a reaction with a color developer included in the liquid-permeable material. Therefore, the temperature history as to how long the medium has been preserved at temperatures higher than the specified temperature can be determined.

Japanese Laid-Open Patent Publication No. 61-53531 discloses a medium which uses a liquid-permeable material whose surface is colored with a colorant, and a detecting agent which includes a color erasing agent and which is contained in a container and discharged upon application of pressure. The detecting agent permeates through the liquid-permeable material and thereby the color of the liquid-permeable material is discolored, resulting in determination of the temperature history. In this case, the color erasing agent has a property such that the liquid solidifies below a specified temperature, and therefore the temperature history as to how long the medium has been preserved at temperatures higher than the specified temperature.

(2) A medium using an acetylene type eutectic mixture which changes its color from pink to metallic green by being preserved at a temperature around 100° C. for about tens hours (U.S. Pat. Nos. 4,189,399, 4,208,186 and. 4,276,190).

(3) A medium in which a dye changes its color from non-color to purple at room temperature for about tens days by a color reaction caused by diffusion of an acid or an alkali (U.S. Pat. No. 4,212,153).

(4) A medium utilizing an oxygen diffusion property of redox dyes (U.S. Pat. No. 3,786,976).

(5) A medium which uses a composition of a free-radical receiving dye and a peroxide and in which a temperature history is determined by the discoloration of a green color of the composition (U.S. Pat. No. 3,966,414).

(6) A medium which uses a coloring reaction of a coloring agent, which is microencapsulated together with a wax which melts at a specified temperature and which is placed on one side of a permeable material, and a color changing agent which is separately placed on the opposite side of the permeable material. A temperature history is determined by the color change caused by the color reaction of the coloring agent with the color changing agent after the microencapsulated coloring agent is destroyed upon application of pressure (Japanese Patent Publication No. 60-55235).

(7) A medium utilizing a coloring reaction in which a triaryl methane dye which has been discolored with a reducing agent colors by diffusion of oxygen (Japanese Laid-Open Patent Publication No. 62-190447).

(8) A medium using microorganism which produces an acid, and a pH indicator (Japanese Laid-Open Patent Publication No. 5-61917).

(9) A medium utilizing a coloring reaction of a radical generator with a dye or a dye precursor (Japanese Laid-Open Patent Publication No. 9-96572).

In addition, media utilizing a melting point, diffusing speed and enzyme activity have been disclosed.

These media utilize a technique in that color density or color tint changes depending on a reaction time of the coloring reaction, or a melting/solidifying phenomenon of a dye, color developer or a color erasing agent.

These media have the following drawbacks:

(1) Since these media utilize the change of a material from a solid state to a liquid state at a specified temperature, materials which have phase-change properties suitable for these media are limited, and therefore the purpose of the media, i.e., the temperature to be detected by the media, is also limited.

(2) Since one or more of the materials used for these media are liquid at a temperature higher than the specified temperature, handling of the materials or manufacturing of the temperature history displaying media is troublesome.

(3) A troublesome process is needed in which a color erasing component in a liquid state is contained in a fine container.

(4) It is not easy to start coloring or color erasing upon application of pressure and the like.

(5) A temperature history displaying area is not an image but is a figure such as squares, circles and the like, and therefore the temperature history cannot be read, for example, by scanners.

(6) When a radical generator is used in the media, the media must be preserved in a dark place.

In addition, Japanese Laid-Open Patent Publication No. 7-253482 discloses a temperature history displaying medium in which a color changing layer including a color changing component is formed on a color forming layer which is preliminarily achieved a colored state. The thus colored color forming layer is discolored by migration of the color changing component which is a plasticizer which is liquid at room temperature. Since the color changing component is liquid at room temperature, it is troublesome to prepare and/or handle the medium. In addition, since in the medium color erasing starts from the time when the color erasing layer is formed, it is impossible to start color erasing at a desired time. In this case, as the inventors describe in the patent application, a color erasing component which is solid at room temperature cannot be used because the component does not migrate.

Japanese Laid-Open Patent Publication No. 7-260955 discloses a temperature history displaying medium in which a color changing layer including a liquid color changing component which is microencapsulated is formed on a color forming layer and which migrates to discolor the color forming layer after the microcapsules are destroyed. In this medium, color changing can be started upon application of pressure at a time when the color changing is desired. However, it is troublesome to start color changing upon application of pressure, and also it is difficult to imagewise press the color changing layer. In addition, a plasticizer which is solid at room temperature cannot be used as the color changing component because the plasticizer does not migrate.

Therefore, a need exists for a temperature history displaying medium which can easily display a history of preservation temperature of goods.

### SUMMARY OF THE INVENTION

Accordingly, an object of the present invention is to provide a temperature history displaying medium which can easily display a temperature history without complicated techniques and processes.

Another object of the present invention is to provide a temperature history displaying medium which can display a history of temperatures as image information such as characters, pictures and barcodes.

Yet another object of the present invention is to provide a temperature history displaying medium which can display a temperature history which considerably corresponds to a degree of damage of foods.

A further object of the present invention is to provide a method for manufacturing the temperature history displaying medium mentioned above.

A still further object of the present invention is to provide a temperature history displaying method in which a temperature history is easily determined without complicated techniques.

To achieve such objects, the present invention contemplates the provision of a temperature history displaying medium which includes a color forming component including an electron donating dye and an electron accepting compound, and a color erasing component, wherein the color erasing component comprises a color erasing agent having a function to discolor the color forming component which is in a colored state, wherein the discoloring is performed upon application of at least one of dotted heat and patterned heat.

Preferably, the color erasing component includes a supercooling agent or the color erasing agent has a supercooling property.

The color erasing component preferably has the color erasing function depending on an environmental temperature.

Preferably, the temperature history displaying medium has at least a color forming layer and a color erasing layer, wherein the color forming layer includes the color forming component and the color erasing layer includes the color erasing component.

Alternatively, the temperature history displaying medium may have a coloring/discoloring layer which includes the color forming component, and the color erasing component which is microencapsulated.

In another aspect of the present invention, a temperature history displaying method is provided which includes the steps of:

providing the temperature history displaying medium mentioned above;

applying at least one of dotted heat and patterned heat to the medium to form a color image in the medium and to imagewise melt the color erasing component;

setting the temperature history displaying medium having the image on or near a good which is to be preserved under temperature conditions for a time; and

determining the temperature history of the good by a change of the image.

The dotted heating or patterned heating is preferably performed with a thermal printhead.

In yet another aspect of the present invention, a method for manufacturing the temperature history displaying medium is provided which includes the steps of:

forming a color forming layer including a color forming component overlying a substrate; and

forming a color erasing layer, which includes a color erasing component, overlying the color forming layer,

wherein the color erasing component has a function to discolor the color forming component in a colored state.

The color forming layer may be formed overlying the color erasing layer.

The method may further include a coloring step of allowing the color forming layer to achieve a colored state before the color erasing layer forming step.

These and other objects, features and advantages of the present invention will become apparent upon consideration of the following description of the preferred embodiments of the present invention taken in conjunction with the accompanying drawings.

### BRIEF DESCRIPTION OF THE DRAWING(S)

FIG. 1 is a graph schematically illustrating a change of a color density of an image with elapse of time in an embodiment of the temperature history displaying medium of the present invention;

FIG. 2 is a graph illustrating temperature changing cycles of a temperature changing test;

FIG. 3 is a graph schematically illustrating a change of a color density of an image with elapse of time in an embodiment of the temperature history displaying medium of the present invention, which is subjected to the temperature changing tests in FIG. 2;

FIG. 4 is a reverse image formed in an embodiment of the temperature history displaying medium of the present invention after an image has been erased;

FIGS. 5 to 19 are graphs illustrating changes of color densities of images, which are formed in embodiments of the temperature history displaying medium of the present invention, with elapse of time;

FIG. 20 is a schematic cross section illustrating an embodiment of the temperature history displaying medium of the present invention;

FIG. 21 is a schematic view illustrating an image recording apparatus useful for the temperature history displaying method of the present invention; and

FIGS. 22 is another schematic view illustrating an image recording apparatus useful for the temperature history displaying method of the present invention.

### DESCRIPTION OF THE PREFERRED EMBODIMENTS

Generally, the present invention provides a temperature history displaying medium which includes a color forming component including an electron donating dye and an electron accepting compound, and a color erasing component, wherein the color erasing component has a function to discolor the color forming component which is in a colored state, wherein the discoloring is performed upon application of at least one of dotted heat and patterned heat. The color erasing component preferably includes a supercooling material having a supercooling property such that when the material is heated at a temperature not lower than a melting point of the material so as to achieve a liquid state and then cooled, the material keeps a supercooling liquid state at a temperature between the melting point and a glass transition temperature thereof, and keeps a frozen state at a temperature not higher than the glass transition temperature, and wherein the material in the supercooling state repeatedly achieves the frozen state and returns to the supercooling liquid state when the material is cooled and heated.

The color erasing agent may serve as the supercooling material.

In the present invention, the term “supercooling liquid state” means, as understood in general, a phenomenon in that when a material is once heated at a temperature not lower than its melting point so as to achieve a liquid state and then cooled below the melting point, the material still keeps the liquid state for a time. When the material achieving the supercooling liquid state is preserved at a temperature not higher than its glass transition temperature, the structure is frozen, i.e., the material achieves a frozen state or a glassy state (hereinafter referred to as a frozen state), and thereby color erasing stops. When the material is heated at a temperature not lower than the glass transition temperature, the material returns to the liquid state. Even in a system in which a supercooling material is mixed with one or more other materials which do not have a supercooling property, the system achieves a supercooling liquid state if the supercooling material is compatible with the materials to be mixed.

Whether a material is a supercooling material, or whether a supercooling material is present in a system can be determined, for example, by a thermal-property analyzing method using a differential scanning calorimeter (DSC). When a supercooling material is heated in a DSC, an endothermic phenomenon which is caused by the phase change of the material from a solid phase to a liquid phase is observed at temperatures near the melting point. However, in the cooling process an exothermic phenomenon which is caused by the phase change of the material from a liquid phase to a solid phase is not observed at temperatures near the melting point (i.e., a solidifying point), and the supercooling material keeps the liquid state even when cooled to a temperature near room temperature (20° C.). In other words, a supercooling material does not return to a frozen state at a solidifying point when cooled after the material is melted, but keeps the liquid state, i.e., a supercooling liquid state, which is a semi-stable state. The supercooling liquid state is maintained until a certain time is elapsed or the material receives a stimulus from outside. If the material is cooled gradually, there is a case in which a supercooling phenomenon cannot be observed. However, in a general condition the supercooling phenomenon can be observed. When a mixture of a supercooling material and another material which is not a supercooling material is subjected to the DSC test, the supercooling phenomenon can be observed.

In the present invention, the supercooling material is defined as follows: when a material is heated to a temperature higher than the melting point of the material by 20° C. or more at a heating speed of 5° C./min, to be perfectly melted, and then cooled at a cooling speed of 5° C./min, the material does not crystallize even when the material is cooled to a temperature lower than the melting point by 10° C. or more.

Hereinafter the difference between the temperature history displaying media utilizing a melting/solidifying phenomenon of a color erasing component and the present invention is explained referring to Japanese Laid-Open Patent Publication No. 61-53531.

The methods utilizing a melting/solidifying phenomenon is typically an on/off type detecting method. Namely, the color erasing component in the temperature history displaying medium achieves a melted state and a frozen state. When the color erasing component is melt at a specified temperature, the erasing component penetrates through a liquid-permeable material and finally reaches a colored component, which is present on the other side of the liquid-permeable material, resulting in color erasure of the colored component. At this point, the penetration is almost independent of the environmental temperature. Therefore this method detects only a time period during which the medium is preserved at temperatures higher than the specified temperature. FIG. 2 is a graph illustrating temperature changing cycles of temperature changing tests. When the melting/solidifying type temperature history displaying medium is subjected to a temperature changing test of S₁ or S₂, the results are almost the same if the temperatures T₁ and T₂ are higher than the specified temperature. Therefore, this medium has a drawback in that the temperature history detected by the medium does not correspond to a degree of damage of foods.

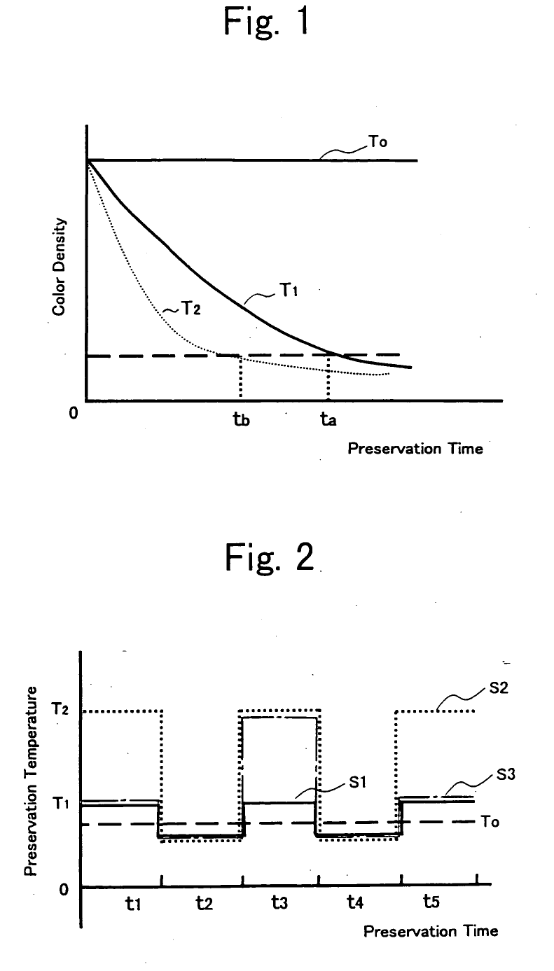

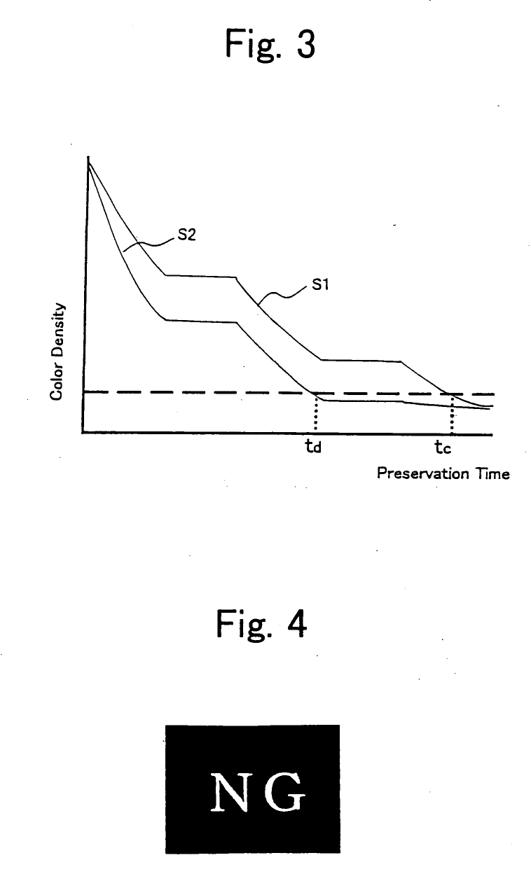

FIG. 1 is a graph schematically illustrating a change of a color density of an image with elapse of time in an embodiment of the temperature history displaying medium of the present invention. The solid line is a color density changing curve when the medium is preserved at a temperature of T₁. The dotted line is a color density changing curve of an image when the medium having the image is preserved at a temperature of T₂ which is higher than T₁. When the medium is preserved at a temperature of T₀, which is a glass transition temperature of the color erasing component, the color density hardly changes. The broken line in FIG. 2 denotes a color density of the medium in which an image is substantially erased. In addition, when the medium having an image is subjected to the temperature changing test S₁ or S₂ as shown in FIG. 2, the color density of the image decreases as the line S₁ or S₂ in FIG. 3. As can be understood from FIGS. 2 and 3, the color density does not decrease during a time period in which the medium is preserved at a temperature below the glass transition temperature T₀. In addition, as can be understood from FIGS. 2 and 3, the color density of the medium of the present invention decreases depending on the environmental temperature and the preservation time. Therefore, the medium of the present invention considerably corresponds to a degree of damage of foods.

The differences between the temperature history displaying medium utilizing a melting/solidifying phenomenon disclosed in Japanese Laid-Open Patent Publication No. 60-55232 and the temperature history displaying medium of the present invention are as follows:

(1) as mentioned above, since this medium also detects only a time period during which the medium is preserved at a temperature higher than the specified temperature, the detected temperature history does not correspond to a degree of damage of foods:

(2) the color erasing operation is started by destroying capsules, which cannot be destroyed by heat and in which a color erasing agent is included, upon application of pressure, which is a troublesome operation; and

(3) image information cannot be formed because it is difficult to imagewise press the medium to form a fine character image and the like.

The temperature history displaying medium of the present invention includes a color forming component and a color erasing component. The color forming component mainly includes an electron donating dye and an electron accepting compound. The electron donating dye and the electron accepting compound react to form a colored product upon application of heat, a solvent or the like. The color erasing component of the present invention has a function to discolor a color forming component in a colored state; and preferably has a supercooling property such that when once heated so as to be melted, the color erasing component keeps a supercooling liquid state even after the component is cooled to a temperature below its melting point, and when the color erasing component in the supercooling liquid state is cooled to a temperature not higher than a glass transition temperature thereof, the component achieves a frozen state, wherein the color erasing component can repeatedly achieve the supercooling liquid state and the frozen state when the color erasing component in the supercooling liquid state is heated and cooled.

Alternatively, the function (A) and property (B) may be achieved by a combination of a color erasing agent which has only the function (A), and a supercooling material which has only the property (B).

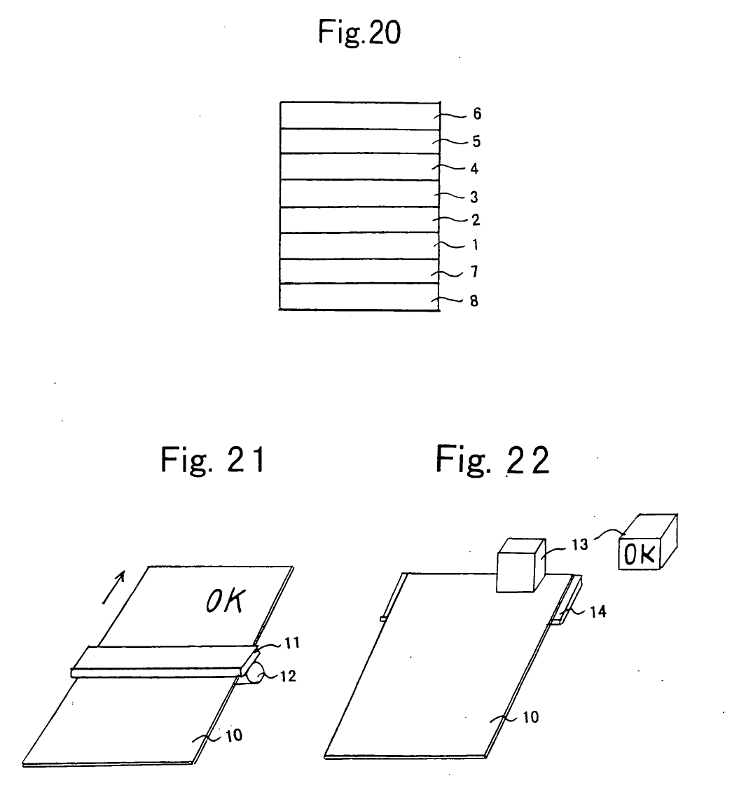

FIG. 20 is a schematic cross section illustrating an embodiment of the history displaying medium of the present invention. In FIG. 20, numerals 1, 2, 3, 4, 5, 6, 7 and 8 denote a substrate, an undercoat layer, a color forming layer, a barrier layer, a color erasing layer, a protective layer, a backcoat layer and an adhesive layer, respectively. The structure of the present invention is not limited thereto.

In detailed description, the temperature history displaying medium of the present invention preferably includes a color forming layer which includes a color forming component mainly including an electron donating dye and an electron accepting compound and which is formed overlying a substrate and a color erasing layer which includes a color erasing component and which is formed overlying the color forming layer. The color erasing layer may be formed overlying a substrate and the color forming layer may be formed thereon. In addition, the temperature history displaying medium of the present invention may include an undercoat layer which is formed between the color forming layer (or the color erasing layer) and the substrate, or a protective layer which is formed on the top of the medium, which are mentioned below. Further, a barrier layer may be formed between the color forming layer and the color erasing layer. When a barrier layer is formed, a color erasing component which is in a supercooling state and which is included in the color erasing layer penetrates through the barrier layer to allow the color forming layer to achieve a discolored state, and therefore the erasing speed decreases. Alternatively, the medium may include a coloring/discoloring layer which includes a color forming component including an electron donating dye and an electron accepting compound, and a color erasing component which is microencapsulated. In addition, one of the electron donating dye and the electron accepting compound may be microencapsulated instead of the color erasing component. The microcapsules may be destroyed by heating, or the component in the microcapsules may penetrate the shell of the microcapsules and diffuse throughout the layer upon application of heat.

Hereinafter the action of the temperature history displaying medium of the present invention is explained. Image information such as “within a shelf life”, “OK” or “NG” is recorded on the temperature history displaying medium of the present invention, which is, for example, label-shaped, using a thermal printhead or the like. The label having an image is attached to a good whose temperature history is to be measured. The good is preserved under any environmental conditions. When the temperature is not lower than the glass transition temperature of the color erasing component, the color erasing component achieves a supercooling liquid state, and gradually penetrates and diffuses across the color erasing layer, and finally reaches the color forming component which is imagewise colored in the color forming layer, resulting in gradual discoloration of the image. In order to control the discoloration speed, a barrier layer is formed between the color forming layer and the color erasing layer. When a barrier layer is formed, the color erasing component penetrates through the barrier layer, the discoloration speed is slower than in the medium which does not have a barrier layer. If the medium is preserved at a temperature lower than the glass transition temperature of the color erasing component, the structure of the color erasing component is frozen and therefore the color erasing of the image almost stops.

If the medium is then preserved at a temperature not lower than the glass transition temperature, the color erasing component achieves a supercooling liquid state again, and therefore the image is gradually discolored. The medium repeats this cycle and finally loses the supercooling property. In other words, the medium can repeat this cycle during a specified period. Therefore, it is important to select supercooling component materials depending on the desired life of a temperature history displaying medium, which is longer than the life of a good whose temperature history is to be determined.

Hereinafter the temperature history displaying medium of the present invention is explained referring to figures and using specific glass transition temperatures.

FIG. 1 is a graph schematically illustrating a change of a color density of an image, which is formed on a temperature history displaying medium of the present invention, with elapse of time. In FIG. 1, preservation temperatures are given as a parameter. The color density shown by the broken line is the density in which an image is considered to be erased (hereinafter referred to as “an erased density level”). Characters T₁ and T₂ denotes temperatures higher than the glass transition temperature T₀ of the color erasing component. In this case, T₂ is higher than T₁. At the temperature of T₁ or T₂, the color density is continuously decreased, and at the temperature of T₀, the decrease of the color density almost stops. It is assumed that the life of a food (A) is 48 hours at 20° C., and the temperature at which the food is to be preserved is 20° C. In this case, a temperature history displaying medium having a discoloring time of 48 hours is used. Namely, a medium should be designed so that the character tₐ (referred to as a discoloring time) is 48 hours when T₁ is 20° C. The image formed on the medium such as “within shelf life” is erased after 48 hours. If the medium is preserved at a temperature T₂, which is higher than the temperature T1 (20° C.), the image is discolored at a discoloring time t_{b}. Namely, the image is discolored faster than the case in which the medium is preserved at T₁ (20° C.). The higher the preservation temperature, the faster the image discolors. In other words, the erasing time of the medium of the present invention considerably corresponds to a degree of damage of foods.

When the medium is preserved under the temperature conditions shown as S₁ in FIG. 2, the color density of the image formed on the medium decreases as the curve of S₁ shown in FIG. 3. When the image is preserved at a temperature which is lower than the glass transition temperature, i.e., at a time of t₂ or t₄, the color density is almost maintained. The effective time in which the image discolors is therefore a total time of t₁, t₃ and t₅, and the image discolors at a discoloring time t_{c}.

When the medium is preserved under the temperature conditions shown as S₂ in FIG. 2, the color density of the image formed on the medium decreases according to the curve of S₂ shown in FIG. 3. The image discolors at a discoloring time t_{d} which is faster than the discoloring time t_{c}.

When the medium is preserved under the temperature conditions shown as S₃ in FIG. 2, the color density changing curve is placed between the curves S₁ and S₂, and the image discolors at a discoloring time between the discoloring times t_{c} and t_{d}.

Hereinafter a case in which the medium having the properties mentioned above is applied to the food (A) mentioned above is explained. It is assumed that T₁ is 20° C. and T₀ is 0° C. When the food (A) is preserved for the time periods of t₂ and t₄ in a refrigerator, in which the temperature is not higher than 0° C., the shelf-life is prolonged to t_{c}. When the food (A) is preserved for the time periods of t₁, t₃ and t₅ at a temperature T₂ higher than 20° C., the shelf-life is shortened to t_{d}.

In this case in which the temperature history can be determined by a degree of decrease of color density of an image, the color forming layer may be colored, for example, with a colored pigment which is not thermosensitive, to improve the readability (contrast) of the image.

Hereinbefore, a case in which image information discolors is explained, however the present invention is not limited thereto. For example, the color forming layer of the medium may be previously colored upon application of heat or a solvent before formation of the color erasing layer, or by coating a color forming layer coating liquid in which a color forming component is solved or dispersed in a proper solvent. Then the colored medium is imagewise heated so as to form an image such as “NG”. The image, which is hardly observed at first, can be observed as a reverse image after a discoloring time because the heated portion is discolored. Namely, if the color forming layer colors black by heating, a white character “NG” can be observed in the black background. In this case, if the color forming layer and/or the substrate are colored, for example, with a red pigment which is not thermosensitive, a red character “NG” appears in the black background after the image is erased.

In addition, the substrate may be colored. If the substrate is colored red and the color forming layer is transparent in the non-colored state and black in the colored state, a red character “NG” appears in the black background.

Suitable electron donating dyes for use in the color forming layer of the temperature history display medium of the present invention include known leuco dyes such as triphenyl methane compounds, fluoran compounds, phenothiazine compounds, auramine compounds, spiropyran compounds, indolinophthalide and the like. These leuco dyes are used alone or in combination.

Specific examples of such leuco dyes include the following compounds.

3,3-bis(p-dimethylaminophenyl)phthalide,

3,3-bis(p-dimethylaminophenyl)-6-dimethylaminophthalide (i.e., crystal violet lactone),

3,3-bis(p-dimethylaminophenyl)-6-diethylaminophthalide,

3,3-bis(p-dimethylaminophenyl)-6-chlorophthalide,

3,3-bis(p-dibutylaminophenyl)phthalide,

3-cyclohexylamino-6-chlorofluoran,

3-dimethylamino-5,7-dimethylfluoran,

3-diethylamino-7-chlorofluoran,

3-diethylamino-7-methylfluoran,

3-diethylamino-7,8-benzfluoran,

3-diethylamino-6-methyl-7-chlorofluoran,

3-(N-p-tolyl-N-ethylamino)-6-methyl-7-anilinofluoran,

3-pilolidino-6-methyl-7-anilinofluoran,

2-[N-(3′-trifluoromethylphenyl)amino]-6-diethylaminofluoran,

2-[3,6-bis(diethylamino)-9-o-chloroanilino]xanthyl benzoic acid lactam,

3-diethylamino-6-methyl-7-(m-trichloromethylanilino)fluoran,

3-diethylamino-7-(o-chloroanilino)fluoran,

3-di-n-butylamino-7-(o-chloroanilino)fluoran,

3-N-methyl-N-n-amylamino-6-methyl-7-anilinofluoran,

3-N-methyl-N-cyclohexylamino-6-methyl-7-anilinofluoran,

3-diethylamino-6-methyl-7-anilinofluoran,

3-(N,N-diethylamino)-5-methyl-7-(N,N-dibenzylamino)fluoran,

benzoyl leuco methylene blue,

6′-chloro-8′-methoxy-benzoindolinospiropyran,

6′-bromo-3′-methoxy-benzoindolinospiropyran,

3-(2′-hydroxy-4′-dimethylaminophenyl)-3-(2′-methoxy-5′-chlorophenyl)phthalide,

3-(2′-hydroxy-4′-dimethylaminophenyl)-3-(2′-methoxy-5′-nitrophenyl)phthalide,

3-(2′-hydroxy-4′-diethylaminophenyl)-3-(2′-methoxy-5′-methylphenyl)phthalide,

3-(2′-methoxy-4′-dimethylaminophenyl)-3-(2′-hydroxy-4′-chloro-5′-methylphenyl)phthalide,

3-(N-ethyl-N-tetrahydrofurfuryl)amino-6-methyl-7-anilinofluoran,

3-N-ethyl-N-(2-ethoxypropyl)amino-6-methyl-7-anilinofluoran,

3-N-methyl-N-isobutyl-6-methyl-7-anilinofluoran,

3-morpholino-7-(N-propyl-trifluoromethylanilino)fluoran,

3-pyrrolidino-7-m-trifluoromethylanilinofluoran,

3-diethylamino-5-chloro-7-(N-benzyl-trifluoromethylanilino)fluoran,

3-pyrrolidino-7-(di-p-chlorophenyl)methylaminofluoran,

3-diethylamino-5-chloro-7-(α-phenylethylamino)fluoran,

3-(N-ethyl-p-toluidino)-7-(α-phenylethylamino)fluoran,

3-diethylamino-7-(o-methoxycarbonylphenylamino)fluoran,

3-diethylamino-5-methyl-7-(α-phenylethylamino)fluoran,

3-diethylamino-7-piperidinofluoran,

2-chloro-3-(N-methyltoluidino)-7-(p-n-butylanilino)fluoran,

3-(N-methyl-N-isopropylamino)-6-methyl-7-anilinofluoran,

3-di-n-butylamino-6-methyl-7-anilinofluoran,

3,6-bis (dimethylamino)fluorenespiro(9,3′)-6′-dimethylaminophthalide,

3-(N-benzyl-N-cyclohexylamino)-5,6-benzo-7-α-naphthylamino-4′-bromofluoran,

3-diethylamino-6-chloro-7-anilinofluoran,

3-diethylamino-6-methyl-7-mesidino-4′,5′-benzofluoran,

3-N-methyl-N-isoproyl-6-methyl-7-anilinofluoran,

3-N-ethyl-N-isoamyl-6-methyl-7-anilinofluoran,

3-diethylamino-6-methyl-7-(2′,4′-dimethylanilino)fluoran, and the like.

Suitable electron accepting compounds for use in the color forming layer, which allow the leuco dyes mentioned above to color when these compounds contact the leuco dyes, include known electron accepting compounds including oxidizing agents. Specific examples of such compounds include the following compounds.

2,2-bis(hydroxyphenyl)propane,

4,4′-isopropylidenediphenyl,

4,4′-isopropylidenebis(o-methylphenol),

4,4′-sec-butylidenebisphenol,

4,4′-isopropylidenebis(2-tert-butylphenol),

p-nitrobenzoic acid zinc salt,

1,3,5-tris(4-tert-butyl-3-hydroxy-2,6-dimethylbenzyl)isocyanuric acid,

2,2-(3,4′-dihydroxyphenyl)propane,

bis(4-hydroxy-3-methylphenyl)sulfide,

4-[β-(p-methoxyphenoxy)ethoxy]salicylic acid,

1,7-bis(4-hydroxyphenylthio)-3,5-dioxaheptane,

1,5-bis(4-hydroxyphenylthio)-5-oxapentane,

phthalic acid monobenzyl ester monocalcium salt,

4,4′-cyclohexylidenediphenol,

4,4′-isopropylidenebis (2-chlorophenol)

2,2′-methylenebis (4-methyl-6-tert-butylphenol),

4,4′-butylidenebis(6-tert-butyl-2-methyl)phenol,

1,1,3-tris(2-methyl-4-hydroxy-5-tert-butylphenyl)butane,

1,1,3-tris(2-methyl-4-hydroxy-5-cyclohexylphenyl)butane,

4,4′-thiobis(6-tert-butyl-2-methylphenol),

4,4′-diphenolsulfone,

4-isopropoxy-4′-hydroxydiphenylsulfone,

4-benzyloxy-4′-hydroxydiphenylsulfone,

4,4′-diphenolsulfoxide

p-hydroxybenzoic acid isopropyl ester,

p-hydroxybenzoic acid benzyl ester,

benzyl protocatechuate,

stearyl gallate,

lauryl gallate,

octyl gallate,

1,3-bis(4-hydroxyphenylthio)propane,

N,N′-diphenylthiourea,

N,N′-di(m-chlorophenyl)thiourea,

3,3′-dichlorophenylthiourea,

salicylanilide,

bis(4-hydroxyphenyl)acetic acid methyl ester,

bis(4-hydroxyphenyl)acetic acid benzyl ester,

1,3-bis(4-hydroxycumyl)benzene,

1,4-bis(4-hydroxycumyl)benzene,

2,4′-diphenolsulfone,

2,2′-diallyl-4,4′-diphenolsulfone,

3,4-dihydroxyphenyl-4′-methyldiphenylsulfone,

1-acetyloxy-2-naphtoic acid zinc salt,

2-acetyloxy-1-naphtoic acid zinc salt,

2-acetyloxy-3-naphtoic acid zinc salt,

α,α-bis (4-hydroxyphenyl)-α-methyltoluene,

complexes of thiocyanic acid zinc salt with antipyrine,

tetrabromobisphenol A,

tetrabromobisphenol S,

4,4′-thiobis (2-methylphenol),

4,4′-thiobis (2-chlorophenol), and the like.

These electron donating dyes and electron accepting compounds are used alone or in combination.

By using plural electron donating dyes, a plurality of color images can be formed in a temperature history displaying medium.

The ratio of the electron accepting compound to the leuco dye is preferably from about 1/1 to about 20/1 by weight, and more preferably from about 2/1 to about 10/1 by weight.

In the present invention, pigments may be included in the temperature history displaying medium to color the medium. When a pigment is used, the pigment can be included in one or more of the undercoat layer, color forming layer, barrier layer, erasing layer, protective layer and substrate of the medium. Suitable pigments for use in the present invention include organic pigments and inorganic pigments. Specific examples of the organic pigments include insoluble azo pigments, polyazo condensation pigments, copper phthalocyanine pigments, quinacridone pigments, dioxazine pigments and the like. Specific examples of the inorganic pigments include titan white, cadmium compounds, iron oxides, chromium oxides and the like. The pigments are not limited thereto. These pigments are used alone or in combination.

The color forming layer may include a binder resin. Suitable binder resins include resins including a hydroxy group or a carboxyl group. Specific examples of such resins include polyvinyl acetal resins such as polyvinyl butyral, and polyvinylacetoacetal; cellulose derivatives such as ethyl cellulose, cellulose acetate, cellulose acetate propionate and cellulose acetate butyrate; epoxy resins; and the like, but are not limited thereto. These resins are used alone or in combination, when used.

The color forming layer may include auxiliary agents such as fillers, surfactants, lubricants, agents for preventing color formation upon application of pressure, and the like. Specific examples of such fillers include inorganic powders such as calcium carbonate, silica, zinc oxide, titanium oxide, aluminum hydroxide, zinc hydroxide, barium sulfate, clay, kaolin, talc, and surface-treated calcium carbonate and silica, and the like; and organic fine powders such as urea-formaldehyde resins, styrene-methacrylic acid copolymers, polystyrene resins, vinylidene chloride resins and the like. Specific examples of such lubricants include higher fatty acids and their metal salts, higher fatty acid amides, higher fatty acid esters, animal waxes, vegetable waxes, mineral waxes, petroleum waxes, and the like.

Suitable supercooling materials for use in the present invention include known compounds having a supercooling property. In general, almost the known supercooling materials can repeat to achieve a supercooling liquid state and a frozen state, although the supercooling period varies depending on the materials. Since various organic compounds having a supercooling property are known, suitable supercooling compounds can be selected depending on the use of the temperature history displaying medium, i.e., the preservation temperature and the preserving time of a good whose temperature history is to be measured.

Suitable supercooling materials for use in the present invention include:

(1) supercooling materials having a color erasing function; and

(2) supercooling materials having no color erasing function. Specific examples of the supercooling materials (1) include phthalic acid esters such as dicyclohexyl phthalate, diphenyl phthalate and the like. The supercooling materials (2) are used together with a color erasing compound, and therefore the materials (2) are preferably compatible with the color erasing compound. Specific examples of the supercooling materials (2) include 3,5-di-tert-butyl-4-hydroxyphenyl)propionic acid methyl ester, 3,5-di-tert-butyl-4-hydroxyphenyl)propionic acid octadecyl ester, bis-3-(3-tert-butyl-4-hydroxy-5-methylphenyl)propionic acid triethylene glycol ester, and the like. The supercooling materials are not limited thereto, These supercooling compounds are used alone or in combination.

Solid plasticizers can also be used as the supercooling materials in the present invention. Suitable plasticizers for use as the supercooling materials include plasticizers having a melting point of from 40 to 150° C., and preferably from 60 to 100° C., to obtain a good preserving property and good thermosensitivity. Specific examples of such solid plasticizers includes dihexyl phthalate, dihydroabiethyl phthalate, dimethyl isophthalate, sucrose benzoate, ethylene glycol dibenzoate, trimethylolethane tribenzoate, ethyleneglycol dibenzoate, tribenzoic acid, trimethylolethane, tribenzoic acid glyceride, tetrabenzoic acid pentaerythritol, octaacetic acid sucrose, citric acid tricyclohexyl, N-cyclohexyl-p-toluenesulfonamide and the like.

Suitable color erasing materials for use as the color erasing component in the color erasing layer include aliphatic amines, amides, piperidines, piperazines, pyridines, imidazoles, imidazolines, morpholines, guanidines, amidines, polyethers, glycols and the like. Specific examples of such compounds include alkylene compounds of bisphenols, adducts of terephthalic acid with ethylene oxide, long chain 1,2-glycols, glycerin esters of fatty acids, urea derivatives, adducts of linear glycols with alkylenes, morpholine derivatives, polyether and polyethylene glycol derivatives, amines or quarternary ammonium salts of guanidine derivatives, aromatic amine derivatives, dioctyl phthalate, dioctyl adipate and the like. The color erasing compounds are not limited thereto. These compounds are used alone or in combination.

The temperature history displaying medium of the present invention may include a protective layer to obtain a good ability to be used with thermal printheads. Preferably, the protective layer is transparent, and has resistance to chemicals and water, and resistance to rubbing and light. The protective layer can be formed by coating aqueous resin solutions or emulsions, or resin solutions using organic solvents, and then dried to form a film layer. In addition, ultraviolet crosslinking resins, electron beam crosslinking resin and the like can also be used as the protective layer.

Specific examples of the water-soluble resins for use in the protective layer of the present invention include polyvinyl alcohol, modified polyvinyl alcohol, cellulose derivatives such as methyl cellulose, methoxy cellulose, hydroxy cellulose and the like, casein, gelatin, polyvinyl pyrrolidone, styrene-maleic acid copolymers, diisobutylene-maleic anhydride copolymers, polyacrylamide, modified polyacrylamide, methyl vinyl ether-maleic anhydride copolymers, carboxyl modified polyethylene, polyvinylalcohol-acrylamide block copolymers, melamine-formaldehyde copolymers, urea-formaldehyde copolymers and the like.

Specific examples of the aqueous emulsions for use in the protective layer include emulsions of resins such as polyvinyl acetate, polyurethane, styrene-butadiene copolymers, styrene-butadiene-acryl copolymers, polyacrylic acid, polyacrylate, vinyl chloride-vinyl acetate copolymers, polybutyl methacrylate, polyvinyl butyral, polyvinyl acetal, ethyl cellulose, ethylene-vinyl acetate copolymers and the like. Copolymers of these resins with a silicone segment are preferably used as the material for the protective layer of the present invention.

These resins are used alone or in combination. In addition, these resins may be used together with a crosslinking agent to be crosslinked.

Suitable ultraviolet crosslinking resins or electron beam crosslinking resins for use in the protective layer include known monomers, oligomers and prepolymers, which can polymerize and crosslink upon application of ultraviolet light or electron beams. Suitable electron beam crosslinking resins include branched polyester resins having five or more functional groups and silicone modified electron beam crosslinking resins.

The protective layer may include a filler such as an inorganic filler and an organic filler, and a lubricant, to improve the ability to be used with thermal printhead. The average particle diameter of the filler is preferably not greater than 0.3 μm. The oil absorption of the filler is preferably not less than 30 ml/100 g, and more preferably not less than 80 ml/100 g. Specific examples of such fillers include inorganic fillers such as calcium carbonate, silica, zinc oxide, titanium oxide, aluminum hydroxide, zinc hydroxide, barium sulfate, clay, talc, and surface treated calcium carbonate and silica, and organic fillers such as urea-formaldehyde resins, styrene-methacrylic acid copolymers, polystyrene resins and the like.

The protective layer can be formed by any known coating method. The thickness of the protective layer is preferably from 0.1 to 20 μm, and more preferably from 0.5 to 10 μm, to maintain a good preservation property and good thermosensitivity and to save manufacturing costs.

In the present invention, the temperature history displaying medium may include an undercoat layer, which is formed between the substrate and the color forming layer (or the color erasing layer), to improve the thermosensitivity of the medium. The undercoat layer is broadly classified into two types, one of which is a non-foaming type undercoat layer in which micro hollow particles which have a thermoplastic resin shell and which have a hollow rate of not less than 30% or porous pigments are used, and the other of which is foaming type undercoat layer in which foaming fillers are used to prepare a foamed undercoat layer upon application of heat. In the present invention, the non-foaming undercoat layer is preferable.

The micro hollow particles for use in the non-foaming type undercoat layer of the present invention include foamed micro particles which include a gas such as air and the like therein. The preferred particle diameter thereof is from 2.0 to 20 μm, and more preferably from 3.0 to 10 μm, to save manufacturing costs and to maintain good thermosensitivity. In addition, the standard deviation of the particle diameter distribution is preferably small. The hollow rate is preferably not less than 30%, and more preferably not less than 50%, to maintain good thermosensitivity.

The hollow rate is defined as follows:

Hollow rate (%)={(inside diameter of a particle)/(outside diameter of the particle)}×100

The shell of the micro hollow particles preferably includes thermoplastic resins. Copolymer resins including vinylidene chloride and acrylonitrile are preferably used as the shell of the micro hollow particles.

Suitable porous pigments for use in the non-foaming type undercoat layer include organic pigments such as urea-formaldehyde resins, and inorganic pigments such as clay, but are not limited thereto.

The non-foaming type undercoat layer is formed, for example, by the following method:

(1) an undercoat layer coating liquid is prepared by dispersing one or more of the micro hollow particles and the porous pigments, which are mentioned above, in water; and

(2) the coating liquid is coated on a substrate and dried to form an undercoat layer.

The preferred coating weight of the undercoat layer is not less than 1 g/m², and preferably from 2 to 15 g/m². The undercoat layer preferably includes a binder resin. The preferred weight ratio of the binder resin to the hollow particles is from 2/98 to 50/50, to securely fix the particles to the substrate.

Suitable binder resins for use in the non-foaming undercoat layer include known water-soluble polymers and aqueous polymer emulsions. Specific examples of such water-soluble polymer include polyvinyl alcohol, starch, modified starch, cellulose derivatives such as methoxy cellulose, hydroxy cellulose, carboxymethyl cellulose, methyl cellulose and ethyl cellulose; polyacrylic acid sodium salt, polyvinyl pyrrolidone, acrylamide/acrylate copolymers, acrylamide/acrylate/methacrylic acid copolymers, alkali metal salts of styrene/maleic anhydride copolymers, polyacrylamide, sodium alginate, gelatin, casein and the like. Specific examples of the aqueous emulsions include latexes of resins such as styrene/butadiene copolymers, styrene/butadiene/acrylate copolymers, and the like; and emulsions of resins such as polyvinyl acetate, vinyl acetate/acrylic acid copolymers, styrene/acrylate copolymers, polyacrylate resins, polyurethane resins and the like.

Suitable foaming fillers for use in the foaming type undercoat layer of the present invention include expandable plastic fillers in which a foaming agent such as low-temperature volatile solvents is covered with a thermoplastic resin shell. The expandable plastic fillers foam upon application of heat. These expandable plastic fillers are known, and various fillers are available. The preferred diameter of the fillers which are in a non-foamed state is from 2 to 50 μm, and preferably from 5 to 20 μm. The preferred diameter of the fillers which are in a foamed state is from 10 to 100 μm, and preferably from 10 to 50 μm. Suitable resins for use as the shell of the plastic fillers include thermoplastic resins such as polystyrene, polyvinyl chloride, polyvinylidene chloride, polyvinyl acetate, polyacrylate, polyacrylonitrile, polybutadiene, and the copolymers of these resins. Suitable foaming agents include propane, butane and the like.

The foaming type undercoat layer can be formed, for example, by the following method:

(1) a coating liquid is prepared by dispersing one or more expandable plastic fillers in a binder resin solution or dispersion;

(2) the coating liquid is coated on a substrate and dried to form a non-foamed undercoat layer; and

(3) the non-foamed undercoat layer is heated, for example, with a hot plate, to form a foamed undercoat layer.

The preferred coating weight of the non-foamed plastic fillers in the undercoat layer is not less than 1 g/m², and more preferably from 2 to 5 g/m². The preferred weight ratio of the binder resin to the hollow particles is from 5/95 to 50/50, to securely fix the particles to the substrate. The foaming temperature depends on the softening point of the thermoplastic resin shell of the plastic filler. The preferred expansion rate of the expandable plastic fillers is from 2 to 4 times, and more preferably from 2 to 3 times.

Since the foamed undercoat layer has a rough surface, the layer is preferably subjected to a calender treatment to obtain a smooth surface.

The undercoat layer may include a plurality of undercoat layers, if desired.

The undercoat layer may include auxiliary agents such as thermofusible materials, surfactants and the like.

The temperature history displaying medium of the present invention may include a barrier layer between the color forming layer and the color erasing layer to control penetrating speed of the color erasing component, i.e., to control the color erasing speed. By changing the material or the thickness of the barrier layer, the color erasing speed can be controlled. Suitable materials for use in the barrier layer include a film which is formed with a water-soluble polymer and which may includes an organic filler or an inorganic filler.

Suitable resins for use in the barrier layer include known film forming resins. Particularly, water-soluble resins are preferable but the resins for use in the barrier layer are not limited thereto. Specific examples of such resins include emulsions such as styrene/butadiene copolymers, styrene/butadiene/acryl copolymers, vinyl acetate resins, vinyl acetate/acrylic acid copolymers, styrene/acrylate copolymers, polyacrylate resins, polyurethane resins and the like; latexes such as SBR, MBR, NBR and the like; water-soluble resins such as polyvinyl alcohol, cellulose derivatives, starch and its derivatives, carboxyl modified polyvinyl alcohol, polyacrylic acid and its derivatives, styrene/acrylic acid copolymers and their derivatives, poly(meth)acrylamide and its derivatives, styrene/acrylic acid/acrylamide copolymers, amino-group modified polyvinyl alcohol, epoxy modified polyvinyl alcohol, polyethyleneimine, isobutylene/maleic anhydride copolymers and their derivatives, and the like.

Suitable fillers for use in the barrier layer include inorganic fillers such as calcium carbonate, silica, zinc oxide, titanium oxide, aluminum hydroxide, zinc hydroxide, barium sulfate, clay, talc, surface treated calcium carbonate and the like; and organic fillers such as urea-formaldehyde resins, styrene/methacrylic acid copolymers, polystyrene resins and the like.

The thickness of the barrier layer is determined depending on the desired color erasing speed.

Suitable microcapsules for use in the present invention include known microcapsules which is prepared by a known method and which use known shell materials. As for the method for preparing microcapsules, known methods such as coacervation methods (for example, U.S. Pat. No. 2,800,458), interfacial polymerization methods (for example, Japanese Patent Publication No. 47-1763), in-situ polymerization methods (for example, Japanese Laid-Open Patent Publication No. 51-9079) and the like, can be used.

Suitable materials for use as the shell of the microcapsules include polyurethane resins, urea resins, epoxy resins, urea/formaldehyde resins, melamine/formaldehyde resins, and the like. Suitable protective agents for protecting the microcapsules include cellulose powders, starch particles, talc, sintered kaolin, calcium carbonate and the like.

The temperature history displaying medium of the present invention may have a magnetic recording layer on the side of the substrate on which the color forming layer and the color erasing layer is formed, or on the opposite side of the substrate.

The magnetic recording layer of the present invention includes a magnetizable material and a binder resin. Suitable magnetizable materials for use in the magnetic recording layer of the present invention include barium ferrite, strontium ferrite, Co-γ-Fe₂O₂, y-Fe₂O₂, and the like. Suitable binder resins for use in the magnetic recording layer of the present invention include water-soluble resins such as polyvinyl alcohol, and aqueous emulsions such as vinyl chloride resins, polyurethane resins, and the like. The magnetic recording layer can be formed by coating a liquid including a magnetizable material and a binder resin, and drying the coated liquid. The magnetic recording layer may include waxes and other additives.

The temperature history displaying medium of the present invention may include a backcoat layer on the side of a substrate which is opposite to the side on which the color forming layer and color erasing layer are formed. The backcoat layer is formed, for example, by coating a coating liquid mainly including an emulsion of hydrophobic polymers or water-soluble polymers which serves as a binder resin. Suitable resins for use as the binder resin in the backcoat layer include resins mentioned above for use in the protective layer or the undercoat layer. In addition, auxiliary agents such as non-foaming fillers, waterproof applying agents, waxes and the like.

The temperature history displaying medium of the present invention may have an adhesive layer on the side of a substrate which is opposite to the side on which the color forming layer and color erasing layer are formed. The adhesive layer may be formed on the backcoat layer. A release paper or film is superimposed on the adhesive layer. By releasing the release paper or film, the temperature history displaying medium can be adhered to a good. Specific examples of the adhesives include polyvinyl acetate resins, vinyl acetate/ethylene copolymers, vinyl acetate/acrylate copolymers, vinyl acetate/maleic acid esters copolymers, ethylene/acrylic acid copolymers, epoxy resins, phenolic resins and the like.

The temperature history displaying medium may be formed on an area of a display label and a reversible or irreversible thermosensitive recording layer in which information is recorded may be formed on another area of the label.

Suitable materials for use as the substrate of the temperature history displaying medium of the present invention include paper, films of polyester resins such as polyethylene terephthalate and polybutylene terephthalate, films of cellulose derivatives such as triacetate cellulose, films of polyolefin resins such as polyethylene and polypropylene, and complex films in which a plurality of these paper and films are laminated each other.

Hereinafter a method for preparing a temperature history displaying medium using a thermal printhead and a method for displaying a temperature history of a good are explained.

FIG. 21 is a schematic view illustrating an image recording apparatus useful for the temperature history displaying method of the present invention. Numerals 10, 11 and 12 denote a temperature history displaying medium, a thermal printhead and a platen roller, respectively. A character image “OK” is recorded in the temperature history displaying medium 10 with the thermal printhead 11 while the medium 10 is fed in a direction illustrated by an arrow. Images can be recorded in a temperature history displaying medium of the present invention at any time desired upon application of proper heat energy using a printer having a thermal printhead. The medium having the image is attached to the good or set beside the good to detect the temperature history of the good. By controlling the recording energy, color density of the images can be freely set, depending on the period to be measured, i.e., the shelf-life of the good. Suitable images include electronic information such as barcodes, and visual information such as characters, pictures and the like. The life of the good can be determined, for example, by one or more of the following methods:

(1) the life can be determined by whether the barcodes can be optically read with a scanner;

(2) the life can be checked by seeing visual information in the medium near which instructions such as “When the picture (or letters and the like) is disappeared, this food cannot be eaten” is described;

(3) the life can be checked by comparing the color density of the recorded visual information such as pictures or letters in the medium to that of the limit sample thereof which is, for example, printed near the recorded visual information; and

(4) the life can be checked by displaying character information such as “NG”, as mentioned above.

The heating device is not limited to thermal printheads, and any heating devices, which can apply dotted or patterned heat, such as devices using a laser, and heated types can be used. FIG. 22 is another image recording apparatus useful for the temperature history displaying method of the present invention. In FIG. 22, numerals 10, 13 and 14 denote a temperature history displaying medium, a heated type having a character “OK”, and a back plate, respectively. An image “OK” can be recorded in the temperature history displaying medium 10 by bringing the heated type 13 into contact with the temperature history displaying medium 10.

Next, the method for manufacturing a previously-colored temperature history displaying medium, which is one kind of the temperature history displaying media of the present invention and in which the color forming layer is previously colored.

The previously-colored temperature history displaying medium is manufactured, for example, by heating the color forming layer at a temperature not lower than the color forming temperature of the color forming layer after the color forming layer is coated and dried. The heating temperature is preferably not lower than a temperature at which the surface of the color forming layer is damaged. In addition, the color density of the colored color forming layer may be controlled so as to be a density level lower than the saturated color density, by controlling the applying heat energy. If an image whose color density is higher than the color density of the colored color forming layer is recorded in the colored color forming layer, the life of a good can be determined by checking whether the density of the image is the same as that of the background. This coloring operation is preferably performed before coating a color erasing layer. If the coloring operation is performed after coating a color erasing layer, the color erasing component in the color erasing layer is melted by the heat, and color erasing of the colored color forming layer is started. When a barrier layer is formed between the color forming layer and the color erasing layer, the coloring operation can be performed before or after the formation of the barrier layer. The formation of the color forming layer and the color erasing layer can be performed continuously or separately. When performed separately, a calender treatment may be subjected to the color forming layer, and a curing operation of the barrier layer may be performed.

The color forming layer may be colored by applying a solvent thereto. Specific examples of such solvents include organic solvents such as acetone, methyl ethyl ketone, ethanol, toluene and the like, but are not limited thereto. Suitable coating methods useful for the solvent application include known coating methods.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Preparation of Coating Liquids

### Preparation of Undercoat Layer Coating Liquid (A)

The following components were mixed and stirred to prepare an undercoat layer coating liquid (A).

| | |
|---|---|
| Micro hollow particles dispersion | 30 |
| (solid content of 27.5%, average particle diameter of | |
| 5 μm, hollow rate of 92%, copolymer mainly including | |
| vinylidene chloride and acrylonitrile) | |
| Styrene/butadiene copolymer latex | 10 |
| Water | 60 |

### Preparation of Color Forming Layer Coating Liquid (D)

The following components were mixed and then pulverized with a ball mill to prepare a dye dispersion (B). The solid in the dispersion had an average particle diameter not greater than 2.0 μm.

| | |
|---|---|
| 6-(dimethylamino)-3,3-bis[4-(dimethylamino)phenyl]- | 20 |
| 1(3H)-isobenzofuranone | |
| (crystal violet lactone) | |
| Polyvinyl alcohol (10% aqueous solution) | 20 |
| Water | 60 |

(At this point, crystal violet lactone colors blue when reacted with an electron accepting compound.)

The following components were mixed and then pulverized with a ball mill to prepare a color developer (an electron accepting compound) dispersion (C). The solid in the dispersion had an average particle diameter not greater than 2.0 μm.

| | |
|---|---|
| 2,2-bis(hydroxyphenyl)propane (i.e., BPA) | 10 |
| Polyvinyl alcohol (10% aqueous solution) | 25 |
| Calcium carbonate | 15 |
| Water | 50 |

The dye dispersion (B) and the color developer dispersion (C) were mixed so that the weight ratio of the dispersion (B) to the dispersion (C) was 1/8, to prepare a color forming layer coating liquid (D).

### Preparation of Barrier Layer Coating Liquid (E)

The following components were mixed and stirred to prepare a barrier layer coating liquid (E).

| | |
|---|---|
| Aluminum hydroxide | 5 |
| Polyvinyl alcohol (10% aqueous solution) | 50 |
| Polyamide epichlorohydrin (10% aqueous solution) | 20 |
| Water | 25 |

### Preparation of Color Erasing Layer Coating Liquids (F) and (G)

The following components were mixed and pulverized with a ball mill to prepare a color erasing layer coating liquid (F). The solid in the dispersion had an average particle diameter not greater than 2.0 μm.

| | |
|---|---|
| Dicyclohexyl phthalate | 40 |
| Polyvinyl alcohol (10% aqueous solution) | 12 |
| Water | 48 |

The following components were mixed and pulverized with a ball mill to prepare a color erasing layer coating liquid (G). The solid in the dispersion had an average particle diameter not greater than 2.0 μm.

| | |
|---|---|
| Isophthaloylbis(N-methylcyclohexylamide) | 10 |
| (color erasing agent) | |
| (3,5-ditert-butyl-4-hydroxyphenyl)propionic acid methyl | 20 |
| ester (supercooling material) | |
| Polyvinyl alcohol (10% aqueous solution) | 10 |
| Water | 60 |

### Preparation of Protective Layer Coating Liquids (H)

The following components were mixed and stirred to prepare a protective layer coating liquid (H).

| | |
|---|---|
| Aluminum hydroxide | 5 |
| Polyvinyl alcohol (10% aqueous solution) | 50 |
| Polyamide epichlorohydrin (10% aqueous solution) | 20 |
| Water | 25 |

### Preparation of Pigment-colored Color Forming Layer Coating Liquids (J)

The following components were mixed and stirred to prepare a pigment liquid (I).

| | |
|---|---|
| Insoluble disazo yellow (35% aqueous solution) | 15 |
| Water | 85 |

The pigment liquid (I) and the color forming layer coating liquid (D) were mixed so that the weight ratio of the liquid (I) to the liquid (D) was 1/5, to prepare a color forming layer coating liquid (J) including a color pigment.

The thus prepared coating liquids were filtered before coating.

### Example 1

The color forming layer coating liquid (D) was coated on a paper substrate and dried to form a color forming layer having a coating weight of 5 g/m² on a dry basis. The color erasing layer coating liquid (F) was coated on the color forming layer and then dried to form a color erasing layer having a coating weight of 5 g/m² on a dry basis. After coating operations, the paper substrate on which a color forming layer and a color erasing layer were formed was then subjected to a calender treatment such that the smoothness of the surface of the coated side was from 500 to 1500 sec. in Bekk smoothness. Thus, a temperature history displaying medium of the present invention was prepared.

### Example 2

The procedure for preparation of the temperature history displaying medium in Example 1 was repeated except that a barrier layer having a coating weight of 1.5 g/m² on a dry basis was formed between the color forming layer and the color erasing layer in the same way as that of the color forming layer. The calender treatment was performed after all layers had been formed.

Thus, a temperature history displaying medium of the present invention was prepared.

### Example 3

The procedure for preparation of the temperature history displaying medium in Example 2 was repeated except that an undercoat layer having a coating weight of 2 g/m² on a dry basis and a protective layer having a coating weight of 1.5 g/m² on a dry basis were formed between the substrate and the color forming layer, and on the color erasing layer, respectively, in the same way as that of the color forming layer. The calender treatment was performed after all layers had been formed.

Thus, a temperature history displaying medium of the present invention was prepared.

### Example 4

The procedure for preparation of the temperature history displaying medium in Example 1 was repeated except that the color erasing layer coating liquid (F) was replaced with the color erasing layer coating liquid (G). The calender treatment was performed after all layers had been formed.

Thus, a temperature history displaying medium of the present invention was prepared.

### Example 5

The procedure for preparation of the temperature history displaying medium in Example 1 was repeated except that the color forming layer coating liquid (D) was replaced with the coloring layer coating liquid (J). The calender treatment was performed after all layers had been formed.

Thus, a temperature history displaying medium of the present invention was prepared.

### Example 6

The procedure for preparation of the temperature history displaying medium in Example 1 was repeated except that the color forming layer was heated at 110° C. for 2 minutes after the color forming layer had been coated and dried, and then cooled to room temperature before forming the color erasing layer, to prepare a colored color forming layer. The calender treatment was performed after all layers had been formed.

Thus, a previously-colored temperature history displaying medium of the present invention was prepared.

### Example 7

The procedure for preparation of the temperature history displaying medium in Example 1 was repeated except that methyl ethyl ketone was coated on the color forming layer after the color forming layer had been coated and dried, to color the color forming layer. The calender treatment was performed after all layers had been formed.

Thus, a previously-colored temperature history displaying medium of the present invention was prepared.

### Example 8

The procedure for preparation of the temperature history displaying medium in Example 6 was repeated except that the color forming layer coating liquid (D) was replaced with the color forming layer coating liquid (J). The calender treatment was performed after all layers had been formed.

Thus, a previously-colored temperature history displaying medium of the present invention was prepared.

### Comparative Example 1

The procedure for preparation of the temperature history displaying medium in Example 1 was repeated except that dicyclohexyl phthalate was removed from the color erasing layer coating liquid (F). The coating weight of the color erasing layer was 5 g/m² on a dry basis.

Thus, a comparative temperature history displaying medium was prepared.

### Comparative Example 2

The procedure for preparation of the temperature history displaying medium in Example 4 was repeated except that Isophthaloylbis(N-methylcyclohexylamide) (color erasing agent) was removed from the color erasing layer coating liquid (G). The coating weight of the color erasing layer was 5 g/m² on a dry basis. The calender treatment was performed after all layers had been formed.

Thus, a comparative temperature history displaying medium was prepared.

The thus prepared temperature history displaying medium of the present invention in Examples 1 to 8 and comparative temperature history displaying medium in Comparative Examples 1 to 2 were evaluated by the following method.

Evaluation Method

Each temperature history displaying medium prepared in Examples 1 to 5 and Comparative Examples 1 to 2 was imagewise heated using an experimental thermal recording apparatus including a thin film thermal printhead made by Matsushita Electronic Components Co., Ltd., to form an image in the temperature history displaying medium. The recording conditions were as follows:

| | |
|---|---|
| Electricity consumption of thermal printhead: | 0.45 w/dot |
| Recording time per 1 line: | 10 msec/line |
| Pulse width: | 0.8 msec |

The recorded image was preserved under temperature conditions of 5° C. and 20° C. The color density was measured with a reflection densitometer RD-914 (manufactured by Macbeth Co.) using a red filter (blue mark position).

Each temperature history displaying medium prepared in Examples 6 to 8 was imagewise heated using an experimental thermal recording apparatus including a thin film thermal printhead made by Matsushita Electronic Components Co., Ltd., to form an image in the temperature history displaying medium. The recording conditions were as follows:

| | |
|---|---|
| Electricity consumption of thermal printhead: | 0.45 w/dot |
| Recording time per 1 line: | 12 10 msec/line |
| Pulse width: | 1.2 msec |

The recorded image was preserved under temperature conditions of 5° C. and 20° C. The color density was measured with a reflection densitometer RD-914 (manufactured by Macbeth Co.) using a red filter (blue mark position).

Results

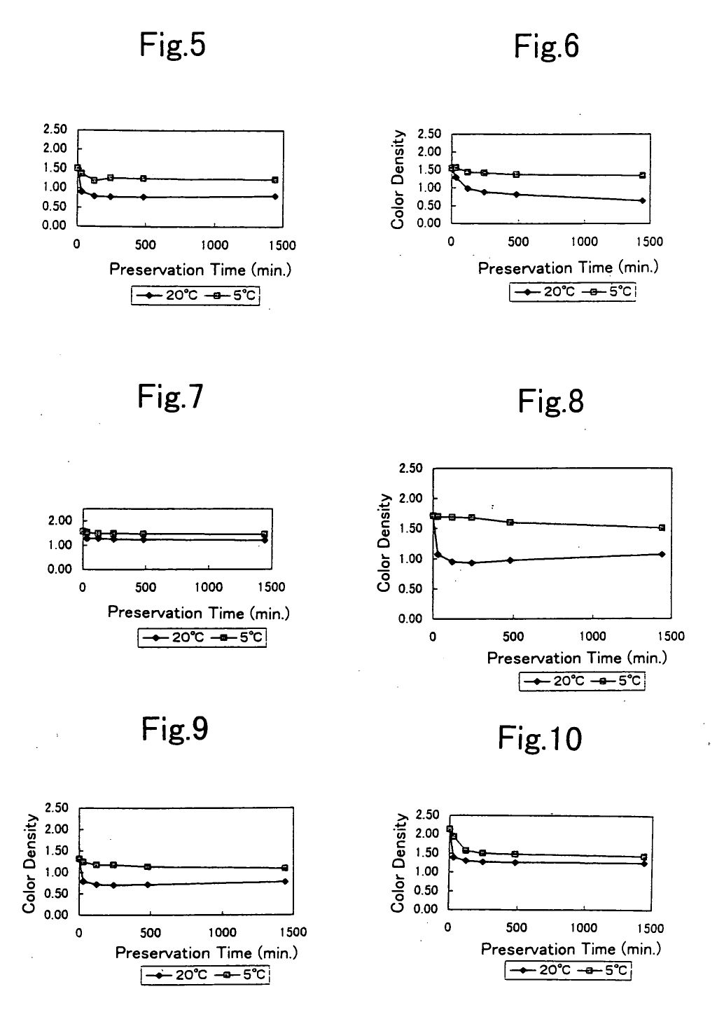

(1) Two images were recorded in the temperature history displaying medium prepared in Example 1 under the recording conditions mentioned above, and one of the images was preserved at 5° C. and the other image was preserved at 20° C. The color densities of the images were changed as shown in FIG. 5. As can be understood from FIG. 5, the color density of each image gradually decreased, and the color erasing speed at 20° C. was faster than that at 5° C.

(2) Two images were recorded in the temperature history displaying medium prepared in Example 2 under the recording conditions mentioned above, and one of the images was preserved at 5° C. and the other image was preserved at 20° C. The color densities of the images were changed as shown in FIG. 6. As can be understood from FIG. 6, the color density of each image gradually decreased, but the erasing speed of the color density of the image was slower than that of the image of the medium of Example 1. This is caused by formation of the barrier layer.

(3) Two images were recorded in the temperature history displaying medium prepared in Example 3 under the recording conditions mentioned above, and one of the images was preserved at 5° C. and the other image was preserved at 20° C. The color densities of the images were changed as shown in FIG. 7. As can be understood from FIG. 7, the color density of each image decreased very slowly. This is considered to be caused by formation of the barrier layer and the protective layer.

(4) Two images were recorded in the temperature history displaying medium prepared in Example 4 under the recording conditions mentioned above, and one of the images was preserved at 5° C. and the other image was preserved at 20° C. The color densities of the images were changed as shown in FIG. 8. As can be understood from FIG. 8, the color density of each image decreased faster than that of the image of the medium of Example 1. In addition, the color density of each image decreased faster than those of the images in Comparative Examples 2 and 3, graphs of which are shown in FIGS. 18 and 19. This is because the color erasing layer of the medium of Comparative Example 2 or 3 includes only a color erasing agent or a supercooling material.

(5) Two images were recorded in the temperature history displaying medium prepared in Example 5 under the recording conditions mentioned above, and one of the images was preserved at 5° C. and the other image was preserved at 20° C. The color densities of the images were changed as shown in FIG. 9. The contrast of the image was better than that of Example 1 because the color of the image was blue and the color of the background was yellow, which was the color of the pigment, insoluble disazo yellow. In addition, the color of the image became a color similar to the background color after the image was erased.

(6) Two images were recorded in the temperature history displaying medium prepared in Example 6 under the recording conditions mentioned above, and one of the images was preserved at 5° C. and the other image was preserved at 20° C. The color densities of the images were changed as shown in FIG. 10. The color of the image was initially similar to the background color (blue); however, after the image was erased at 20° C. a white image (i.e., the color of the paper substrate) was formed in the blue background, as shown in FIG. 4.

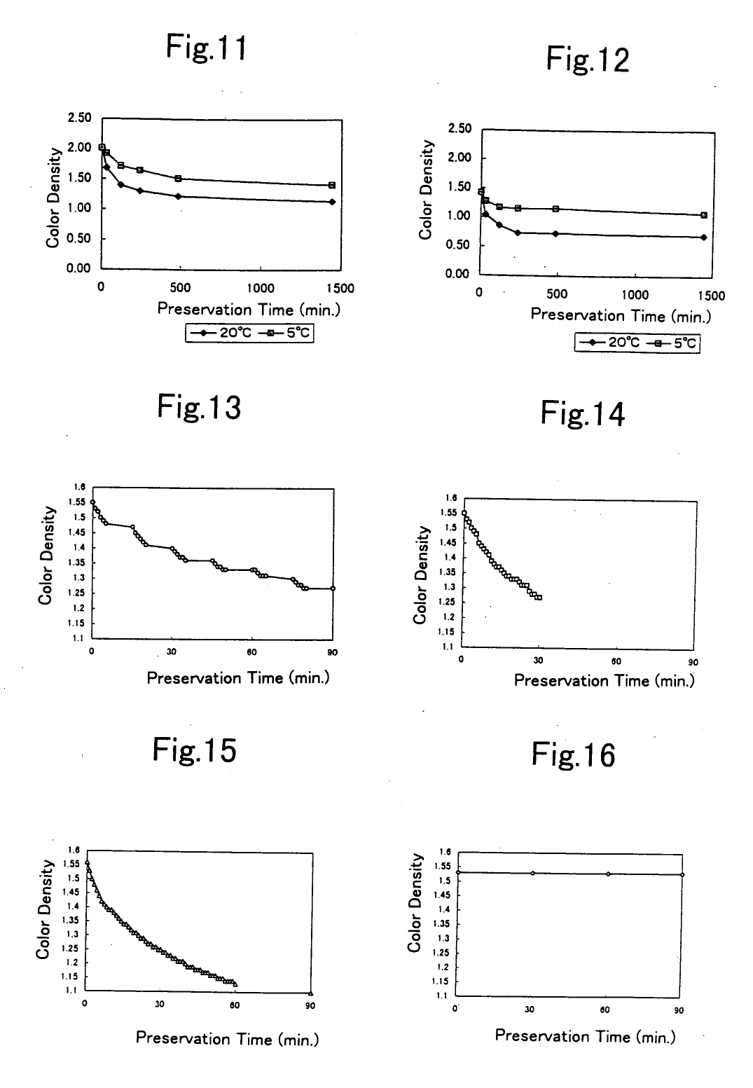

(7) Two images were recorded in the temperature history displaying medium prepared in Example 7 under the recording conditions mentioned above, and one of the images was preserved at 5° C. and the other image was preserved at 20° C. The color densities of the images were changed as shown in FIG. 11. The color of the image was initially similar to the background color (blue); however, after the image was erased at 20° C. a white image (i.e., the color of the paper substrate) was formed in the blue background, as shown in FIG. 4.

(8) Two images were recorded in the temperature history displaying medium prepared in Example 8 under the recording conditions mentioned above, and one of the images was preserved at 5° C. and the other image was preserved at 20° C. The color densities of the images were changed as shown in FIG. 12. The color of the image was initially similar to the background color (blue); however, after the image was erased at 20° C. a yellow image (i.e., the color of the pigment, insoluble disazo yellow) was formed in the blue background, as shown in FIG. 4. The image had a good contrast.

(9) Three images were recorded in the temperature history displaying medium prepared in Example 2 under the recording conditions mentioned above, and one of the images was preserved at −20° C., another of which was preserved at 20° C., and the other image was preserved under temperature conditions in which a temperature cycle in which a temperature of −20° C. was kept for 10 minutes and then a temperature of 20° C. was kept for 5 minutes was repeated. The color densities of the images were changed as shown in FIGS. 13 to 17.

The color density did not decrease at −20° C. as shown in FIG. 16, because the glass transition temperature of the supercooling material is higher than −20° C. The color density gradually decreased at 20° C. as shown in FIG. 15.

When the image was preserved under the temperature cycling condition, the color density thereof deceased as shown in FIG. 13. The color density hardly decreased during the time when the image was preserved at −20° C. and the color density gradually decreased during the time when the image was preserved at 20° C. If the color density changing curve in FIG. 13 is modified such that the portions during which the image was preserved at −20° C. are removed, the modified curve is shown in FIG. 14. The line shown in FIG. 14 is almost the same as that in FIG. 15.

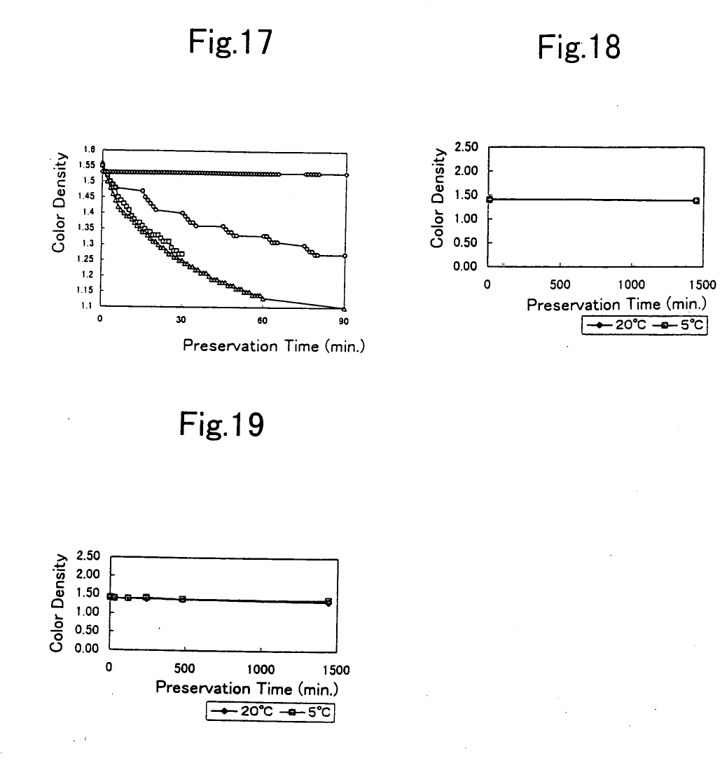

All the graphs shown in FIGS. 13 to 16 are illustrated in FIG. 17. It is clearly observed that the line in FIG. 14 is similar to that in FIG. 15. As can be understood from FIG. 17, the graphs shown in FIG. 17 are very similar to the graphs shown in FIGS. 1 and 3, which are schematic graphs.

(10) Two images were recorded in the temperature history displaying medium prepared in Comparative Example 1 under the recording conditions mentioned above, and one of the images was preserved at 5° C. and the other image was preserved at 20° C. The color densities of the images were changed as shown in FIG. 18. The color density was 1.48 and did not change when the image was preserved at 5° C. or 20° C. for 1440 minutes. The color erasure did not occur because there was no color erasing component having a supercooling property, dicyclohexyl phthalate, in the color erasing layer.

(11) Two images were recorded in the temperature history displaying medium prepared in Comparative Example 2 under the recording conditions mentioned above, and one of the images was preserved at 5° C. and the other image was preserved at 20° C. The color density of the image was changed as shown in FIG. 19. The color density did not change when the image was preserved at 5° C. or 20° C. for 1440 minutes. The color erasure did not occur because there was only a supercooling material in the color erasing layer, which did not have a color erasing function.

As mentioned above, the temperature history displaying medium of the present invention has the following advantages:

(1) the temperature history detected by the medium considerably corresponds to a degree of damage of foods;

(2) the temperature to be detected can be freely and easily changed by changing the melting point and glass transition temperature of a supercooling material used;

(3) the medium can be easily manufactured without complicated technique such that a liquid color erasing component is microencapsulated;

(4) color erasing can be started at any time desired by heating with a thermal printhead;

(5) various images (information) can be formed on the medium; and

(6) the medium can be handled and preserved in a light place.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Applications Nos. 10-085019 and 10-242984, filed on Mar. 16, 1998, and Aug. 28, 1998, respectively, the entire contents of which are herein incorporated by reference.

What is claimed is:

1. A temperature history displaying medium comprising a color forming component which comprises an electron donating dye and an electron accepting compound and which achieves a colored state by a reaction of the electron donating dye and the electron accepting compound, and a color erasing component comprising a color erasing agent having a function to discolor the color forming component in the colored state, wherein the discoloring is triggered upon application of at least one of dotted heat and patterned heat, and wherein a temperature history is determined depending on the discoloring state of the color forming component in the colored state.

2. The temperature history displaying medium according to claim 1, wherein the color erasing component further comprises a supercooling material having a supercooling property such that when the color erasing component is heated at a temperature not lower than a melting point of the color erasing component so as to achieve a liquid state and then cooled, the color erasing component keeps a supercooling liquid state at a temperature between the melting point and a glass transition temperature of the color erasing component, and keeps a frozen state at a temperature not higher than the glass transition temperature, wherein the color erasing component in the supercooling liquid state repeatedly achieves the frozen state and returns to the supercooling liquid state when the color erasing component in the supercooling liquid state is cooled and heated.

3. The temperature history displaying medium according to claim 2, wherein the color erasing agent serves as the supercooling material.

4. The temperature history displaying medium according to claim 1, wherein the temperature history displaying medium further comprises a substrate, a color forming layer which comprises the color forming component, and a color erasing layer which comprises the color erasing component, and wherein the color forming layer and the color erasing layer are overlaid on one side of the substrate.

5. The temperature history displaying medium according to claim 4, wherein the temperature history displaying medium further comprises a barrier layer which is formed between the color forming layer and the color erasing layer.

6. The temperature history displaying medium according to claim 4, wherein the temperature history displaying medium further comprises a protective layer which is formed on the side of the substrate on which the color forming layer and the color erasing layer are formed.

7. The temperature history displaying medium according to claim 4, wherein the temperature history displaying medium further comprises an undercoat layer which is formed on the side of the substrate on which the color forming layer and the color erasing layer are formed and which is closer to the substrate than the color forming layer and the color erasing layer.

8. The temperature history displaying medium according to claim 7, wherein the undercoat layer comprises micro hollow particles having a hollow rate not less than about 30%.

9. The temperature history displaying medium according to claim 4, wherein the temperature history displaying medium further comprises an adhesive layer which is formed on a side of the substrate which is opposite to the side on which the color forming layer and the color erasing layer are formed.

10. The temperature history displaying medium according to claim 9, wherein the temperature history displaying medium further comprises a backcoat layer which is formed between the adhesive layer and the substrate.

11. The temperature history displaying medium according to claim 1, wherein the temperature history displaying medium comprises a substrate, and a coloring/discoloring layer which is formed overlying the substrate and which comprises the color forming component and the color erasing component, and wherein the color erasing component is microencapsulated.

12. The temperature history displaying medium according to claim 1, wherein the temperature history displaying medium comprises a substrate, and a coloring/discoloring layer which is formed overlying the substrate and which comprises the color forming component and the color erasing component, and wherein at least one of the electron donating dye and the electron accepting compound is microencapsulated.

13. The temperature history displaying medium according to claim 1, wherein the color forming component comprises a plurality of electron donating dyes.

14. The temperature history displaying medium according to claim 1, wherein the temperature history displaying medium further comprises a color pigment.

15. The temperature history displaying medium according to claim 1, wherein the color erasing component comprises a plasticizer which is solid at room temperature.

16. The temperature history displaying medium according to claim 15, wherein the plasticizer has a melting point of from about 40 to about 150° C.

17. A temperature history displaying method comprising the steps of:
providing a temperature history displaying medium comprising a color forming component which comprises an electron donating dye and an electron accepting compound and which achieves a colored state by a reaction of the electron donating dye and the electron accepting compound, and a color erasing component which comprises a color erasing agent, wherein the color erasing agent has a function to discolor the color forming component in the colored state;
applying at least one of dotted heat and patterned heat to the temperature history displaying medium to form a colored image in the temperature history displaying medium and to imagewise heat the color erasing agent;
allowing the temperature history displaying medium having the colored image to set together with a good whose temperature history is to be determined; and
determining the temperature history of the good by a change of the image.

18. The temperature history displaying method according to claim 17, wherein the heat applying step is performed with a thermal printhead.

19. The temperature history displaying method according to claim 17, wherein the change of the image is an erasing degree of the image.

20. The temperature history displaying method according to claim 17, wherein the change of the image is a change of color tone of the image.

21. The temperature history displaying method according to claim 17, wherein the temperature history displaying medium has sides and includes a color forming layer which comprises the color forming component and a color erasing layer which comprises the color erasing component, both layers being formed on the same side of the temperature history displaying medium, wherein the method further comprises an image information recording step of recording image information overlying the side of the temperature history displaying medium on which the color forming layer and the color erasing layer are formed, wherein the image information substantially disappears when the colored image is formed, and wherein the temperature history of the good is determined by the ability of the image information to be visually observed as a result of the discoloring of the colored image.

22. The temperature history displaying method according to claim 17, wherein the change of the image is optically detected with a scanner.

23. A temperature history displaying method comprising the steps of:
providing a temperature history displaying medium comprising a color forming component which comprises an electron donating dye and an electron accepting compound and which preliminarily achieves a colored state by a reaction of the electron donating dye and the electron accepting compound, and a color erasing component which comprises a color erasing agent, wherein the color erasing agent has a function to discolor the color forming component in the colored state when the color erasing component is heated;
applying at least one of dotted heat and patterned heat to the colored temperature history displaying medium to imagewise heat the color erasing component;
allowing the temperature history displaying medium to set together with a good whose temperature history is to be determined; and
determining a temperature history of the good by a change of the imagewise heated portion of the temperature history displaying medium.

24. The temperature history displaying method according to claim 23, wherein the heat-applying step is performed with a thermal printhead.

25. The temperature history displaying method according to claim 23, wherein the change of the image is an erasing degree of the imagewise heated portion of the temperature history displaying medium.

26. The temperature history displaying method according to claim 23, wherein the change of the image is a change of color tone of the imagewise heated portion of the temperature history displaying medium.

27. The temperature history displaying method according to claim 23, wherein the temperature history displaying medium includes a substrate, a color forming layer which comprises the color forming component and a color erasing layer which comprises the color erasing component, wherein at least one of the substrate, the color forming layer and the color erasing layer is colored a color different from the color of the colored color forming component, and wherein the temperature history of the good is determined by an image visually observed as a result of the discoloring of the colored color forming component.

28. The temperature history displaying method according to claim 23, wherein the change of the image is optically determined with a scanner.

29. A method for manufacturing a temperature history displaying medium comprising the steps of:
forming a color forming layer overlying one side of a substrate, said color forming layer comprising a color forming component which comprises an electron donating dye and an electron accepting compound and which achieves a colored state by a reaction of the electron donating dye and the electron accepting compound;
forming a color erasing layer, which comprises a color erasing component which comprises a color erasing agent, overlying the color forming layer; and
optionally forming a protective layer overlying the color erasing layer,
wherein the color erasing agent has a function to discolor the color forming component in the colored state, wherein the discoloring is triggered upon application of at least one of dotted heat and patterned heat, and wherein a temperature history is determined depending on the discoloring state of the color forming component in the colored state.

30. The method according to claim 29, wherein the method further comprises a coloring step of;
allowing the color forming layer to achieve a colored state before the color erasing layer forming step.

31. The method according to claim 30, wherein the coloring step is performed by heating the color forming layer.

32. The method according to claim 30, wherein the coloring step is performed by coating an organic solvent on the color forming layer.

33. A method for manufacturing a temperature history displaying medium comprising the steps of:
forming a color erasing layer, which comprises a color erasing component which comprises a color erasing agent, overlying one side of a substrate;
forming a color forming layer overlying the color erasing layer, said color forming layer comprising a color forming component which comprises an electron donating dye and an electron accepting compound and which achieves a colored state by a reaction of the electron donating dye and the electron accepting compound; and
optionally forming a protective layer overlying the color forming layer,
wherein the color erasing agent has a function to discolor the color forming component in the colored state, wherein the discoloring is triggered upon application of at least one of dotted heat and patterned heat, and wherein a temperature history is determined depending on the discoloring state of the color forming component in the colored state.

34. A method for manufacturing a temperature history displaying medium comprising the steps of:
forming, in overlying relation to one side of a substrate, a coloring/discoloring layer which comprises a color forming component and a color erasing component which is microencapsulated, said color forming component comprising an electron donating dye and an electron accepting compound and which achieves a colored state by a reaction of the electron donating dye and the electron accepting compound, and said color erasing component comprising a color erasing agent having a function to discolor the color forming component in the colored state; and
optionally forming a protective layer overlying the coloring/discoloring layer,
wherein the discoloring is triggered upon application of at least one of dotted heat and patterned heat, and wherein a temperature history is determined depending on the discoloring state of the color forming component in the colored state.

35. The method according to claim 29, further including at least one of the following steps:
(a) forming an undercoat layer on said one side of the substrate and forming the color forming layer overlying the undercoat layer;
(b) forming a barrier layer overlying the color forming layer and forming the color erasing layer overlying the barrier layer.

36. The method according to claim 33, further including at least one of the following steps:
(a) forming an undercoat layer on said one side of the substrate and forming the color erasing layer overlying the undercoat layer;
(b) forming a barrier layer overlying the color erasing layer and forming the color forming layer overlying the barrier layer.

37. The method according to claim 34, further including the step of forming an undercoat layer on said one side of the substrate and forming the coloring/discoloring layer overlying the undercoat layer.
